(19) United States
(12) Patent Application Publication
(10) Pub. No.: US 2008/0133134 A1
(43) Pub. Date: Jun. 5, 2008

(54) Personal situational analysis system

(76) Inventors: Edward W. Ronish, Laurel, MD (US); James R. Perry, Corrales, NM (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/634,787

(22) Filed: Dec. 5, 2006

(51) Int. Cl. G01C 21/00; G01S 5/00

(52) U.S. Cl. 701/213; 701/200; 701/207

(57) ABSTRACT

A personal situational analysis system provides an enhanced situational awareness through a display of the location and environmental aspects of a network of similar units. It senses the local environment and provides time-stamped environmental data to a common processing unit. It is compact enough for use as a mobile device moving through a changing environment in a three dimensional space. The sensing and display unit displays environmental information pertinent to the user to determine their future actions, based on situational analysis (SA), to avoid collisions, plot ideal paths to a specific location and avoid hazardous situations. A data analysis unit is part of the solution and may be a replication of the mobile hardware or larger, more powerful version. The data analysis unit provides the situational analysis and information update to the mobile hardware on a periodic basis.

### GOVERNMENT RIGHTS

The U.S. Government has a paid-up license in this invention and the right in limited circumstances to require the patent owner to license others on reasonable terms as provided for by the terms of MDA972-01-9-0018 awarded by the Defense Advanced Research Projects Agency (DARPA).

### BACKGROUND OF THE INVENTION

1. Field of the Invention (Technical Field)

This invention relates to participative networking of sensors and more specifically to a system of participative environmental sensors for situational awareness and display.

2. Background Art

Typically, a combination Global Positioning System (GPS) and Family Radio Service/General Mobile Radio Service (FRS/GMRS) band radio provides a unit's position information to other units. However, this combination only addresses a single aspect of a user's need to understand their local environment. These devices do not contain an integrated display, sensors, GPS and communications devices. In addition, the current approaches are either bulky, high cost units applied to a single aspect of the user's environment or are personal devices with very limited environmental measurement and display capabilities. They do not provide additional environmental data communication between units.

There are prior art patents that relate to using a fleet of aircraft to provide precise weather data over a wide area for enhanced aviation weather information, such as described in U.S. Pat. No. 6,937,937 B1. Unlike the present invention, that patent provides only location and local atmospheric data. In addition, another system is required for presentation of the locations of other aircraft in the immediate area, whereas the present invention includes both systems in one.

There are also a series of devices sold by Garmin International, Inc. that provide a combination GPS and communications radio in a handheld unit with a display. These devices are the RINO (Radio Integrated with Navigation for the Outdoors). RINOs communicate with other similar units to provide each RINO radio/GPS unit with the other unit's location so they can track and display the location of up to 50 similar units. Some versions contain a barometric sensor for measuring altitude, but do not display that information on the remote units.

U.S. Pat. No. 6,373,430 describes a device that covers the “peer-to-peer position reporting” feature on the RINO product line of GPS-enabled, two-way radios. The patent covers a portable device that combines GPS and radio technologies that enable the device to transmit its position to another such device, and a system and method for indicating the location of one portable GPS/radio device on the display of another portable GPS/radio. However, the claimed invention does not display information about the user's environment to other users, it simply communicates the location of each device to the other.

The prior art described above differs from the present invention in that the present invention integrates multiple sensors into each device for the ability to present a multi-facetted and integrated “view” of the user's environment.

In addition, the present invention can not only monitor the user's environment but can also communicate that environment to a base processor for combining with data from other similar units for transmission back to the entire set of portable units.

### SUMMARY OF THE INVENTION (DISCLOSURE OF THE INVENTION)

A personal situational analysis apparatus and method provides mobile environmental sensors that the user is interested in monitoring, and provides the user with information not only from his local sensor, but with information from other remote sensors carried by other users with the same environmental interest. Distributed environmental sensing can greatly enhance the accuracy and resolution of the data needed by the users. For example, weather information is typically gathered at a few wide-spread specific measuring sites and extrapolated to provide information for locations without measuring equipment. By adding more sensors to the system, the resolution and the accuracy of the data can be increased.

The described embodiments may be applied in any situation where individuals or objects interact with each other or their environment.

A primary object of the present invention is to provide a multi-facetted and integrated view of a user's environment. Multiple sensors can increase the resolution and accuracy of the data being collected.

A primary advantage of the present invention is that it greatly enhances the accuracy and resolution of data needed by users. For example, using this system can provide a situational awareness for operators of conglomerations of moving objects (like hot air balloons).

Another advantage of the present invention is that it is easily adaptable to use in varied environments that can not only monitor the user's environment but can also communicate that environment to a data analysis processor for combining with data from other similar units for transmission and displaying back to the entire set of portable units.

Another advantage is that it is low cost.

Yet another advantage is that it can be as small as a hand held device.

Yet another advantage is that it allows numerous separate entities to benefit from a broad set of information from all the participating entities through ad hoc communications.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 shows a sensing and display unit or data analysis unit block diagram of the personal situational analysis system.

FIG. 2 shows the personal situational analysis system with a Radio and GPS system.

FIG. 3 shows a hardware block diagram of the personal situational analysis system with Radio and GPS.

### DESCRIPTION OF THE PREFERRED EMBODIMENTS

### Best Modes for Carrying Out the Invention

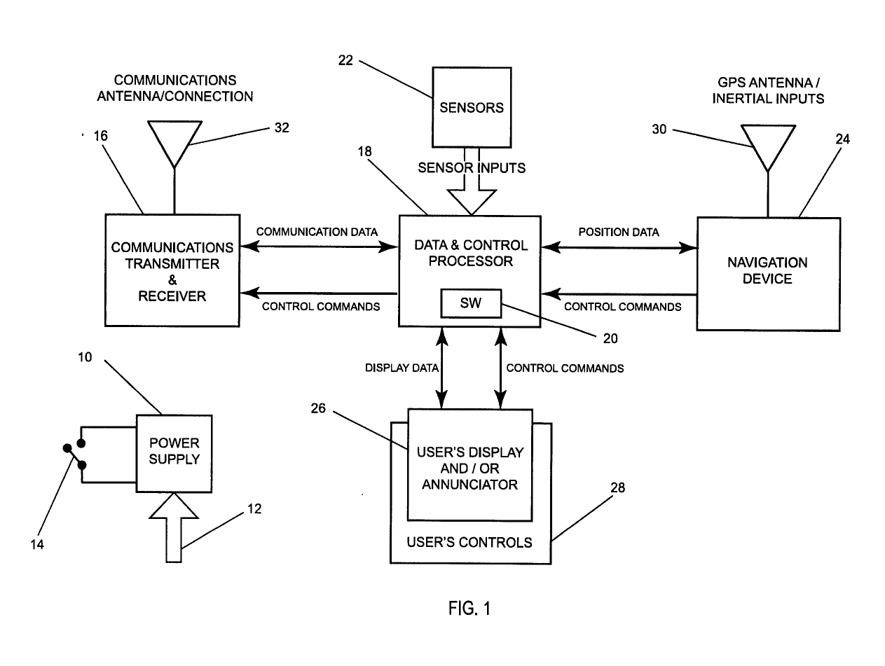

FIG. 1 shows a mobile or base unit block diagram of the preferred embodiment. This embodiment can be a mobile/hand-held unit or a portable personal computer (PC) with a larger display. In this embodiment, power source 12 is applied to power supply 10 which activates power switch 14. Power supply 10 supplies the appropriate power to communication transmitter and receiver 16 which can be a radio or other type of device such as a wired or optical communication connection. Data and control processor 18 starts the execution of data and control software (SW) 20 to sensors 22, navigation apparatus 24 which can be a GPS or any other position sensing device, and to user display and/or annunciator 26 and user's controls 28. For a typical hand held or portable implementation, applying power source 12 entails installing batteries or connecting the embodiment to an external power source. Navigation or position locating apparatus 24 determines the current location and velocity of the embodiment based on inputs 30 from GPS satellite signals, or inertial inputs or a combination of both. To initiate the process, sensors 22 start measuring the local environment. Communications transmitter and receiver 16 automatically become part of the ad hoc communications network of similar units and start sending the environmental and location data via the communications connection or antenna 32 to data analysis unit 34.

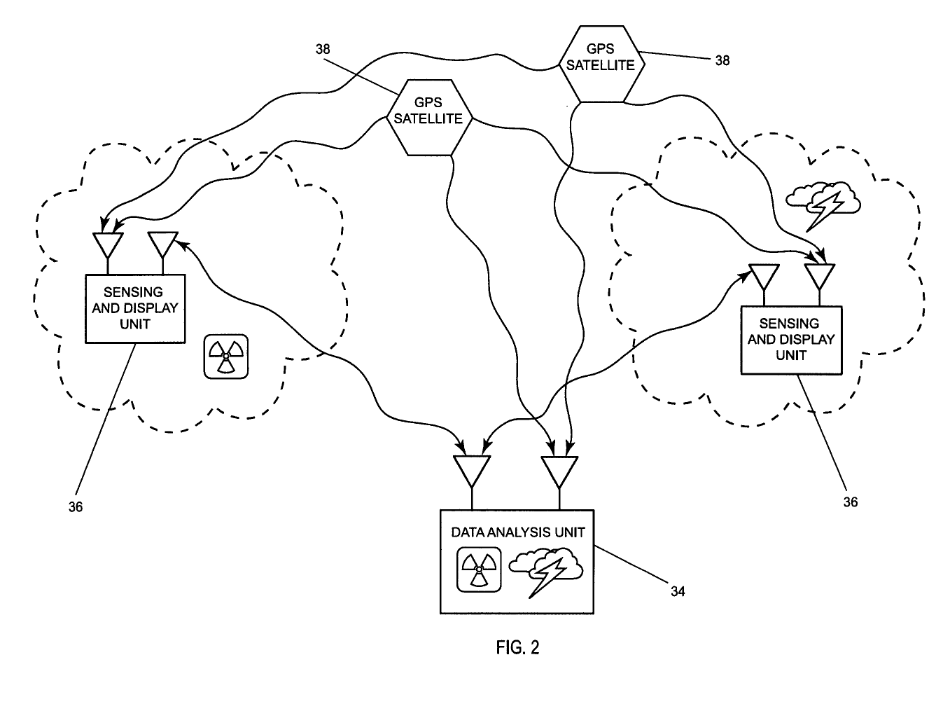

FIG. 2 shows the system's sensing and display unit and data analysis unit with Radio and GPS. All units either receive radio signals from the constellation of GPS Satellites 38 for use in calculating the unit's position or they calculate their position based on other methods such as inertial references from an inertial navigation unit or using a known fixed location. Data analysis unit 34 sends information to sensing and display unit 36 based on inputs from other similar sensing and display units 36 on the network. The amount and type of information may be limited or controlled in other ways to use only the appropriate information from specific sensing and display units 36 and to provide only the appropriate information to a specific sensing and display unit 36. Information may be limited by what the user has contracted and paid for, or it may be limited by the user to a specific subset of data that is currently of interest. Information may be further controlled by the user via user's controls 28 that select display characteristics, such as range or area of interest, threshold values for certain parameters to de-clutter user displays and/or annunciator 26 when measurements are below certain levels, as shown in FIG. 1. The user may also set warning levels to provide additional alerts when approaching areas that have above threshold values for specific measurements. Display 26 can indicate the area where measurements from other units, for example, indicate above threshold values for specific measurements and locations or it can be used to display a “map” of wind vectors or an area where gas concentrations are hazardous.

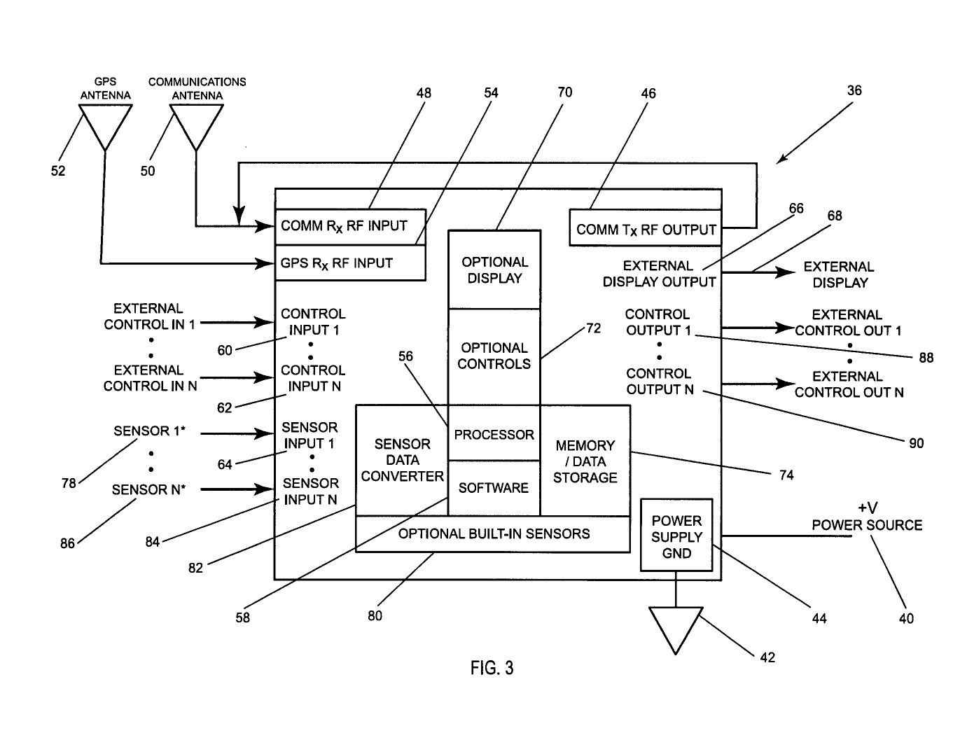

FIG. 3 is the hardware block diagram of the preferred embodiment of sensing and display unit 36 with radio and GPS. Data analysis unit 34 with radio and GPS is similarly configured. Although the description below is for a typical sensing and display unit, the description is also meant to describe a typical data analysis unit 34.

Power for the sensing and display units 36 hardware is supplied from a power source such as batteries or an AC to DC converter, via power source 40 and return or ground connection 42. Power to the invention is supplied by power supply 44 to meet the power requirements of sensing and display unit 36, which is dependent on the desired specific implementation. Power supply 44 can contain a switch for turning sensing and display unit 36 on and off (not shown).

Hardware for sensing and display unit 36 communicates with data analysis unit 34 via a communication system that may be radio frequency transmitter 46, receiver 48, and communication antenna 50. Other well known methods of communication such as optical or sonic transmitters and receivers can also be used. The communications sub-system passes location and sensor data to the data analysis unit. The communications sub-system also receives processed data from all the mobile/fixed units in the network via the data analysis unit.

When using a global positioning system (GPS) for determining the position of sensing and display unit 36, GPS antenna 52 and receiver/processor 54 receive the GPS satellite signals and provide raw data to the unit's position processor 56, where it is further processed into position, velocity, and time. In an alternative embodiment, GPS receiver 54 can contain an integrated processor for determining the unit's position and providing that time stamped data directly to the preferred embodiment's other sub-systems. Other position determining methods, such inertial sensor systems or fixed positioning, can be used that do not require the use of GPS receiver and processor 54. These other methods can include a clock to time correlate all data.

The preferred embodiment also contains processor 56 that executes software 58 to calculate the invention's position and velocity using information from GPS Receiver 54. Processor 56 also interprets external control inputs 60 and optional (internal) control inputs 72. External control inputs 60 are not attached to sensing and display unit 36, whereas internal control inputs 72 are physically attached to sensing and display unit 36. As shown, more than one external control input 62 can be used. The control inputs change the calculations done by processor 54 to adapt the various embodiments for specific needs. For example, an input could adjust the level of sensor input 64 that would drive external display output 66 to an external display 68 or alarm. Processor 54 also calculates the data necessary to drive optional display 70 to provide color, shading, symbols, text and other visual indications of the preferred embodiment's operation.

Optional controls 72 are controls incorporated into the preferred embodiment for the purpose of adjusting the response to meet the needs of the user in any particular environment or application. Optional controls 72 can be moved off of sensing and display unit 36 and provided as external control inputs 60 to provide the same functionality as optional controls 72. The use of controls is dictated by the particular application and desired information.

To support processor 56, memory/data storage 74 allows short term storage of intermediate data as generated by processor 56. When this data is needed for longer periods, memory/data storage 74 retains data calculated by processor 56 for extended periods. Memory types for both short term memory and long term storage can be selected to meet the needs of processor 56 and can include solid state, magnetic, or other types of volatile or non-volatile memory.

Sensor Inputs 64 are inputs from external sensors 78 that measure the appropriate environmental parameters for the selected specific application. As is shown, there can be a number of sensor inputs 84 from a number of external sensors 86. External sensors 78 can include but are not limited to, temperature, humidity, specific gas concentration levels, radiation levels, pressure, and more. Outputs from these sensors can be in the form of analog or digital data provided electrically or by other means, such as optical.

Optional built-in sensors 80 are similar to external sensors 78, but are contained as part of sensing and display unit 36. Internal sensors 80 provide the same functionality as external sensors 78.

All sensor data that is not in a format that can be used directly by processor 56, is passed through sensor data converter 82. Sensor data converter 82 converts and scales sensor data to a format required by processor 56.

Control inputs 60 and 62 select how the embodiment responds to sensor inputs 64 and 84. Control inputs 60 and 62 are located remotely from sensing and display unit 36. They can be connected to sensing and display unit 36 by hard wired connections, by radio frequency interfaces (such as Blue Tooth®)), or other means. Control inputs 60 and 62 can be used in conjunction with optional controls 72 located on sensing and display unit 36.

Control outputs 88 and 90 are generated to provide control of external devices, such as alarms, automatic response devices like fire suppression equipment, ventilation devices, and motion devices.

The preferred embodiment is also capable of providing visual indications of the network's environment. This may be in the form of a color or black and white video display with symbology to aid the user in understanding the nature of the environment within the space monitored by the invention's units. The visual presentation may be on an optional self-contained display 70 or on an external visual display 68 driven by external display output 66. Either display may be as simple as an indicator device (light or mechanical flag) or as complex as a large screen video display. The video output format is consistent with the type of display being driven.

The preferred process of the invention is described below. Power is applied between power source 40 and ground 42 by an off-on switch, or the like. This causes power supply 44 to apply power to all of the sub-systems.

Processor 56 begins operation and performs any self-test or other initialization steps as required. Processor 56 is controlled by software 58, the settings of optional controls 72, the settings of external control inputs 60 and 62, and the data in memory/data storage 74.

Once initialized, processor 56 accepts inputs from external sensor inputs 64 and 84 and optional built-in sensors 80 as processed by sensor data converter 82. The processed sensor data is scaled and digitized as necessary to correctly interface with processor 56 and software 58. Processor 56 also accepts data from optional control inputs 72 and external control inputs 60 and 62 when executing software 58.

Inputs from communications receiver 48 can contain control data from the data analysis unit 34 and can be used by processor 56 when executing software 58. In addition, the data from GPS receiver 54 or other position locating device, which is also sensor type data, is input to processor 56 and is used for providing the calculations.

The above inputs and operative features calculate the specified local environmental conditions for transmittal to the data analysis unit 34. The data sent to data analysis unit 34 includes the environmental measurement, the location where the measurement was made, and the time of the measurement. This data is combined by data analysis unit 34, with the data from other units in the network to define a view of the environment in the space occupied by the networked units.

The view of the networked units' environment is transmitted by data analysis unit 34 back to all of the networked units for use by their operators or by the equipment connected to each unit. To display the environment of the networked units, each unit uses its own processor 56 to convert the data received from the data analysis unit via communications antenna 50 and receiver 48 to a video signal. This signal drives the display connected to the unit. The display can be an optional display 70, or it may be an external display 68 that is driven by external display output 66. The specifics of the display parameters are determined by software 58, sensor inputs 64 and 84, built in sensors 80, GPS inputs 54, and control inputs 60 and 62 and optional controls 72. For direct activation of a device such as a valve or motor, external control outputs 88 and 90 may be used with or without a display. External control outputs 88 and 90 can also activate an alarm or safety device or provide a control means for some environmental parameter, such as temperature.

### INDUSTRIAL APPLICABILITY

The invention is further illustrated by the flowing non-limiting examples.

### EXAMPLE I

The first example demonstrates the invention's capability when used by hundreds of hot air balloons flying in a confined area. Visualize 600 hot air balloons all flying at the same time within the confines of a city. Again, referring to FIGS. 1-3, each balloon is equipped with a sensing and display unit 36. Each sensing and display unit 36 transmits positional information, latitude, longitude, altitude, velocity and acceleration back to data analysis unit 34. Data analysis unit 34 slices the data, synthesizes it together, and transmits the data of the last minute of all of the balloons progress. The data are transmitted back to sensing and display units 36 on each balloon. The user in the hot air balloon can look at the data and see a playback of the movements of all of the balloons over the past minute via optional display 70 or external display 68. In addition, data analysis unit 34 can apply a model of wind patterns, based on the movements of the balloons. This second data shows the actual wind patterns over the past minute. This data is transmitted from data analysis unit 34 to sensing and display units 36. The user in the balloon can look at this second data via optional display 70 or external display 68 and see what the wind patterns are in the vicinity of his balloon and make real-time decisions based on the displays shown on sensing and display unit 36.

### EXAMPLE II

The second example involves military use of the present invention. Each soldier in a platoon is supplied with a sensing and display unit 36. Each sensing and display unit 36 is equipped with external sensor 78 (in this case, the sensor is a gas sensor). Sensing and display units 36 measure the environmental, location and time data for each soldier. Data analysis unit 34 receives the data from each of the soldier's sensing and display units 36 and each gas sensor 78. The data is combined and time sliced by data analysis unit 34. Then data analysis unit 34 generates situational data with all of the soldiers' movements. The data of the movements is transmitted back to individual sensing and display units 36 and viewed by the soldiers via optional display 70 or external display 68. Each soldier can see how he is moving relative to the rest of the platoon. A second data set can also be generated by using data generated from gas sensors 78 and transmitted to data analysis unit 34. For instance, if there is a poisonous gas cloud moving in the area, then the second data set is sent to the individual sensing and display units 36 and the soldiers can view how the gas cloud is moving relative to his platoon with either optional display 70 or external display 68. Based on the situational data generated by data analysis unit 34, which is transmitted to sensing and display units 36 and displayed on sensing and display unit 36 using either optional display 70 or external display 68, each soldier can see if the gas cloud is likely to move in his direction.

The preceding examples can be repeated with similar success by submitting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A situational analysis system for presenting environmental conditions, the system comprising:
at least one sensing and display unit, each sensing and display unit from the at least one sensing and display unit comprising at least one sensor, a first communication apparatus and a navigation apparatus; and
a data analysis unit comprising a second communication apparatus for receiving data from the at least one sensing and display unit and a processor for compiling the received data for presenting a present environmental condition and for computing a predicted environmental condition.

2. The situational analysis system of claim 1 wherein said navigation apparatus comprises a position sensing apparatus.

3. The situational analysis system of claim 2 wherein said position sensing apparatus comprises at least one member from the group consisting of a GPS unit an inertial navigation unit and a fixed known location unit.

4. The situational analysis system of claim 1 wherein said navigation apparatus comprises velocity determination apparatus.

5. The situational analysis system of claim 1 wherein said at least one sensor comprises an external sensor.

6. The situational analysis system of claim 1 wherein said at least one sensor comprises an internal sensor.

7. The situational analysis system of claim 1 wherein said first communication apparatus comprises a transmitter and a receiver.

8. The situational analysis system of claim 1 wherein each sensing and display unit comprises a display for displaying the present environmental condition and the computed predicted environmental condition.

9. The situational analysis system of claim 8 wherein said display comprises an onboard display.

10. The situational analysis system of claim 8 wherein said display comprises a remote display.

11. The situational analysis system of claim 1 wherein data analysis unit further comprises a controller for presenting predetermined present environmental conditions and predetermined predicted environmental conditions.

12. A method for presenting a situational analysis of predetermined environmental conditions, the method comprising the steps of:
providing at least one sensing and display unit;
sensing a present environmental condition by each sensing and display unit of the at least one sensing and display unit;
determining a position of each sensing and display unit;
communicating said present environmental condition and position of each sensing and display unit to a data analysis unit;
compiling the sensed present environmental condition and the determined position of each sensing and display unit by the data analysis unit;
calculating a predicted environmental condition by the data analysis unit; and
transmitting the predicted environmental condition and the sensed present environmental condition and position data from the data analysis unit to the at least one sensing and display unit.

13. The method of claim 12 wherein the step of determining a position comprises calculating velocity of each sensing and display unit

14. The method of claim 12 further comprising a step for displaying the predicted environmental condition and the sensed present environmental condition and position data of each sensing and display unit.

15. The method of claim 13 wherein the step of displaying comprises displaying the predicted environmental condition and the sensed present environmental condition and position data of each sensing and display unit on an onboard display.

16. The method of claim 13 wherein the step of displaying comprises displaying the predicted environmental condition and the sensed present environmental condition and position data of each sensing and display unit on an external display.

17. The method of claim 12 further comprising a step for controlling a transmission of the predicted environmental condition and the sensed present environmental condition and position data to the at least one sensing and display unit.

18. The method of claim 12 wherein the step of sensing comprises providing an internal sensor.

19. The method of claim 12 wherein the step of sensing comprises providing a remote sensor.

20. The method of claim 12 further comprising the step of authenticating each sensing and display unit by the data analysis unit.
